(19) United States
(12) Patent Application Publication
(10) Pub. No.: US 2010/0031578 A1
(43) Pub. Date: Feb. 11, 2010

(54) ADA COMPLIANT COLLAPSIBLE THRESHOLD FOR USE WITH A SLIDING DOOR ASSEMBLY

(76) Inventor: Chris Hartwell, Suwanee, GA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/186,897

(22) Filed: Aug. 6, 2008

(51) Int. Cl. E06B 1/70

(52) U.S. Cl. 49/468

(57) ABSTRACT

ADA compliant collapsible thresholds for use with sliding door assemblies are disclosed herein. In an embodiment, a bottom assembly for a sliding door includes a threshold having an upper moveable surface, a lower stationary surface and flexible connectors therebetween, wherein the upper moveable surface is capable of moving towards the lower stationary surface when sufficient downward pressure is applied to the upper moveable surface; and a sill member having a track capable of attaching with the sliding door and allowing lateral reciprocating motion of the sliding door and further comprising at least one recess capable of attaching with the threshold. In an embodiment, the threshold has an overall height equal to or less than about 0.75 inches when the upper moveable surface collapses onto the lower stationary surface.

### BACKGROUND

Various types of access doors for dwellings are known. One such access door is a sliding door assembly which includes one movable panel (the sliding door) and one fixed-panel (the fixed-panel door). Sliding door assemblies are particularly utilizable in residential and business dwellings for their appearance and functionality however, unique problems exist with such sliding door assemblies. One such concern in the manufacture of sliding door assemblies is the door sill. The sill is that portion of the assembly which one passes over when moving through the door closure. Local building codes often specify sills that are tall, in order to block entry of water into the interior of the dwelling between the door panels. For example, in some states, sill requirements are often a few inches in height. These height requirements have not taken into consideration the handicapped or otherwise wheelchair-bound person in mind. There are numerous instances of conflict between building codes requiring such barriers to prevent damages from water penetration and federal regulations covering ADA (Americans with Disabilities Act) Standards for Accessible design.

### SUMMARY OF THE DISCLOSURE

ADA compliant collapsible thresholds for use with sliding door assemblies are disclosed herein.

According to an embodiment of the present invention, there is disclosed a bottom assembly for a sliding door that includes a threshold having an upper moveable surface, a lower stationary surface and flexible connectors therebetween, wherein the upper moveable surface is capable of moving towards the lower stationary surface when sufficient downward pressure is applied to the upper moveable surface; and a sill member having a track capable of attaching with the sliding door and allowing lateral reciprocating motion of the sliding door and further comprising at least one recess capable of attaching with the threshold.

According to an embodiment of the present invention, there is disclosed a sliding door assembly that includes a sliding door movable between a closed position and an open position; and a door frame surrounding and supporting the sliding door, the door frame including a bottom assembly having a threshold with an upper moveable surface, a lower stationary surface and flexible connectors therebetween, wherein the upper moveable surface is capable of collapsing onto the lower stationary surface when sufficient downward pressure is applied to the upper moveable surface.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIGS. 1A and 1B depict one embodiment of an ADA compliant collapsible threshold of the present invention. The threshold is shown in a raised or protective position such that the threshold acts as a weather-stripping device. FIG. 1A is a perspective view of the threshold in the raised position. FIG. 1B is a side view of the threshold in the raised position;

FIGS. 2A and 2B depict the threshold of FIGS. 1A and 1B after sufficient downward pressure is applied to an upper moveable surface of the threshold. As shown in FIGS. 2A and 2B, the threshold has collapsed down. FIG. 2A is a perspective view of the threshold in a collapsed position. FIG. 2B is a side view of the threshold in the collapsed position;

FIGS. 3A and 3B depict the threshold of FIGS. 1A and 1B in use with a bottom assembly for a sliding door. FIG. 3A is a perspective view showing a partial portion of the bottom assembly with the threshold. FIG. 3B is a side view showing a partial portion of the bottom assembly with the threshold;

FIGS. 4A and 4B depict the bottom assembly and threshold of FIGS. 3A and 3B after sufficient downward pressure is applied to the upper moveable surface of the threshold. FIG. 4A is a perspective view showing a partial portion of the bottom assembly having the threshold. FIG. 4B is a side view showing a partial portion of the bottom assembly having the threshold;

FIGS. 5A and 5B depict a sliding door assembly having the bottom assembly and threshold of FIG. 3A. FIG. 5A is a perspective view showing a partial portion of the sliding door assembly with the threshold in the raised position. FIG. 5B is a perspective view showing a partial portion of the sliding door assembly after sufficient downward pressure is applied to the upper moveable surface of the threshold;

FIGS. 6A and 6B depict a portion of the sliding door assembly of FIG. 5A. FIG. 6A is a fragmentary side view of the sliding door assembly showing a sliding door frame engaging the raised threshold. FIG. 6B is a perspective view of FIG. 6A;

FIGS. 7A-7D are close-up views of an embodiment of a sliding door assembly of the present invention during use. Pressure from a wheelchair tire moving across the bottom assembly causes the raised threshold to move from the raised position to the collapsed position.

### DETAILED DESCRIPTION

In one embodiment of the present invention, a bottom assembly for a sliding door is provided that includes a threshold having an upper moveable surface, a lower stationary surface and flexible connectors therebetween, wherein the upper moveable surface is capable of moving towards the lower stationary surface when sufficient downward pressure is applied to the upper moveable surface; and a sill member having a track capable of attaching with the sliding door and allowing lateral reciprocating motion of the sliding door and further comprising at least one recess capable of attaching with the threshold. The threshold is maintained in a “raised position”, thus providing a positive barrier to air and water infiltration, until sufficient downward pressure is applied to the upper moveable surface of the threshold. The downward pressure moves the upper moveable surface towards the lower stationary surface, thus bringing the threshold to a “collapsed position”. Each of the aspects of the threshold and the sill member are now discussed in greater detail.

As used herein, the term “weather-strip” means a material or device used to seal an opening, such as an opening between the door panels of a sliding door assembly. The goal of a weather-strip is to prevent rain and water from entering the sliding door assembly by either blocking it outright or by blocking most of it and returning or rerouting it. A secondary goal of a weather-strip may be to keep interior air in, thus saving energy with heating and air conditioning.

As used herein, the term “weather-stripping device” is used to refer to a collapsible threshold of the present invention that acts as a weather-strip.

As used herein, the term “weatherstripping” refers to the additional use of an extra weather-strip at an upper moveable surface of the threshold of the present invention. Types of weatherstripping materials include, but are not limited to, tension seals (plastic or vinyl self-sticking strip), felt (plain or reinforced with a flexible metal strip), reinforced foam, pile weatherstrip, tape, rolled or reinforced vinyl, magnetic, tubular rubber and vinyl, reinforced silicone and fin seal.

As used herein, the term “collapsing” or “collapsible” refers to a threshold of the invention that can buckle or change shape.

As used herein, the term “water and air infiltration” means the ability of water and/or air to move into an interior space.

As used herein, the term “bottom assembly” means that portion of a sliding door assembly that serves as a durable base that diverts water away from the door and dwelling. The bottom assembly is susceptible to water and air infiltration and acts as an entry through an opening created in a doorway.

As used herein, the term “lateral reciprocating motion” means sideways motion relative to a door frame that can repeat over and over again.

As used herein, the term “rigid” refers to a material that is deficient in or devoid of flexibility. Rigid materials include, but are not limited to, aluminum and a rigid polyvinyl chloride material.

As used herein, the term “flexible connectors” refers to materials that are capable of bending when sufficient downward pressure is applied to the material. Materials suitable for use as flexible connectors include, but are not limited to, a flexible polyvinyl chloride material and a flexible polypropylene material, such as ethylene propylene diene.

As used herein, the term “supporting” means bearing the weight of. In an embodiment of the invention, a door frame of a sliding door assembly is capable of supporting a sliding door and a fixed-panel door.

As used herein, the term “engaging” or “engaged” means contacting or to make contact with something.

As used herein, the term “raised position” or “protective position” means a position where a threshold is capable of acting as a weather-strip.

As used herein, the term “collapsed position” or “access position” means a state where a threshold has collapsed, or changed its profile, such that accessibility through an opening created in a sliding door assembly is achieved.

As used herein, the term “buckle” means to distort or collapse under physical pressure.

As used herein, the term “stationary” means incapable of being moved.

As used herein, the term “accessibility” means the degree to which a sliding door assembly allows access to people with disabilities.

As used herein, the term “Americans with Disabilities Act” or “ADA” means the civil rights law that prohibits, under certain circumstances, discrimination based on disability. Disability is defined as “a physical or mental impairment that substantially limits a major life activity.” According to the current ADA Accessibility Guidelines, Section 4.13.8, Thresholds at Doorways, “Thresholds at doorways shall not exceed ¾ inch (19 mm) in height for exterior sliding doors . . . . ”

As used herein, the term “protrusion” means a part of a material or device that sticks out. In an embodiment of the invention, a lower stationary surface of the threshold has at least one protrusion for engaging at least one recess of a sill member of the bottom assembly.

As used herein, the term “recess” means a space formed by the receding of a sill member material.

As used herein, the term “maintained” means to be kept in a steady or stationary position.

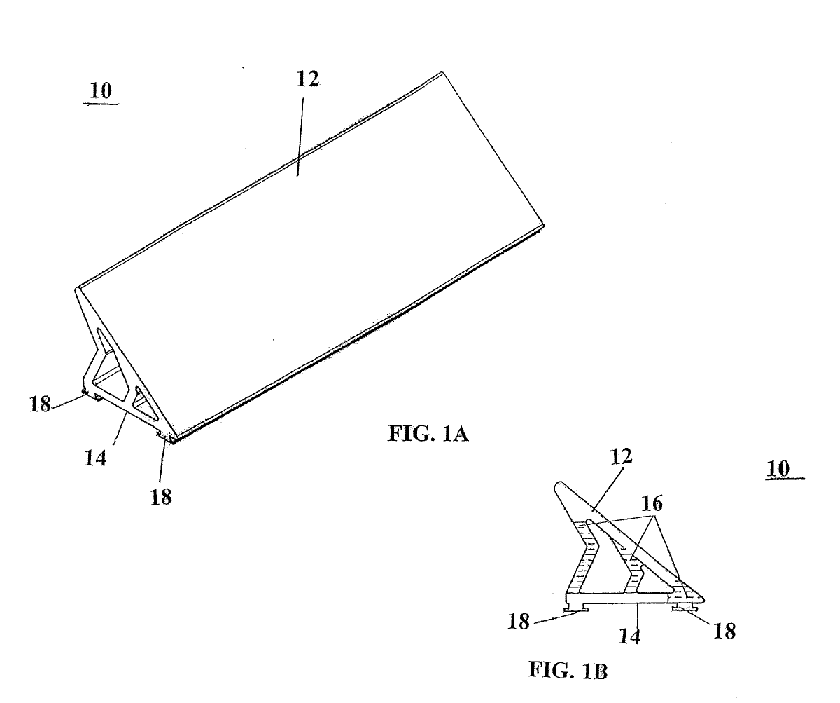

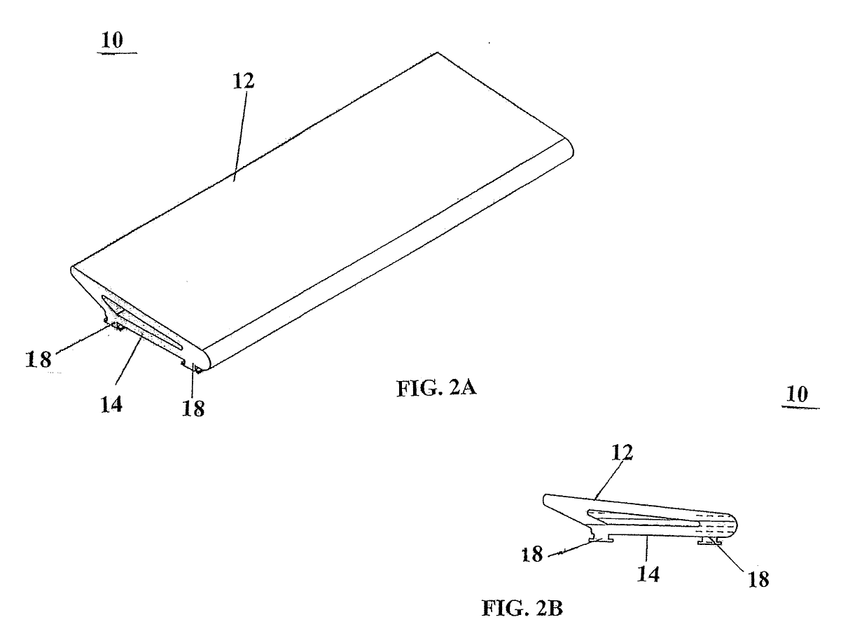

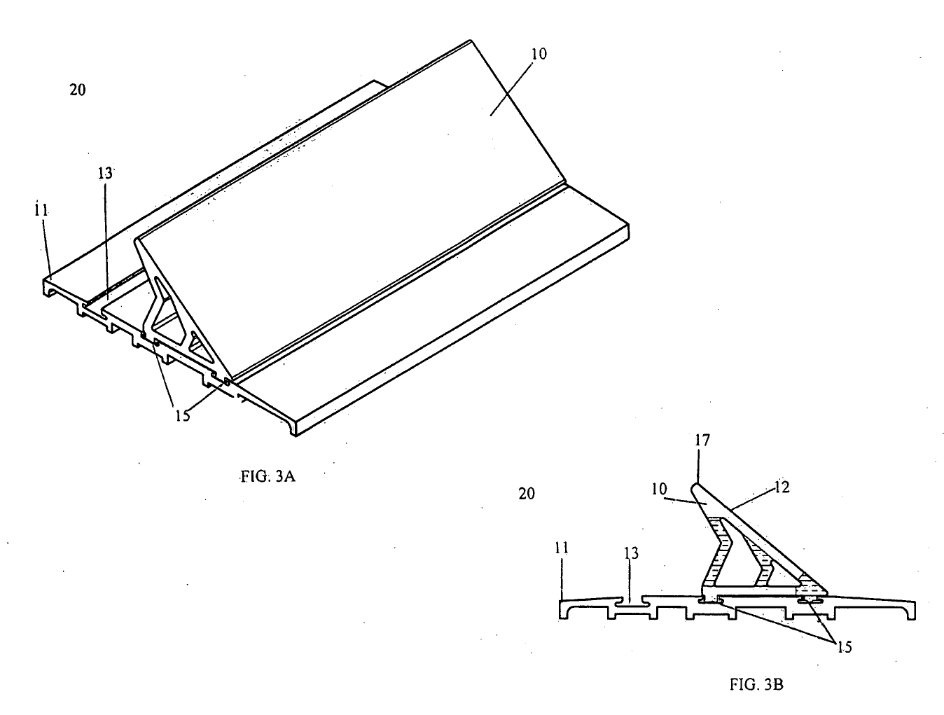

Referring to FIGS. 1A-1B and FIGS. 2A-2B, in one embodiment a threshold 10 includes an upper moveable surface 12, a lower stationary surface 14 and a series of flexible connectors 16 therebetween. The flexible connectors 16 join the upper moveable surface 12 to the lower stationary surface 14. In a “raised” or “protective” position, as shown in FIGS. 1A and 1B, the flexible connectors 16 of the threshold 10 are in a fully extended position, and place the upper moveable surface 12 at an upwards slope relative to the lower stationary surface 14. The flexible connectors 16 are capable of buckling when sufficient downward pressure is applied to the upper moveable surface 14, and are capable of rebounding back into the fully extended position when the pressure is removed from the upper moveable surface 14. The buckling of the flexible connectors 16 results in the upper moveable surface 12 moving in a downward direction and folding onto the lower stationary surface 14, as shown in FIGS. 2A-2B. The lower stationary surface 14 includes at least one protrusion 18 for engaging at least one corresponding recess in a sill member, as will be described in detail below. In the embodiments shown in the various figures, the lower stationary surface 14 includes two protrusions 18.

The upper moveable surface 12 and the lower stationary surface 14 are fabricated from rigid materials that are resistant to harsh environmental elements (e.g., heat, oxidation, ozone and weather aging). Rigid materials include, but are not limited to, aluminum and rigid polyvinyl chloride. The flexible connectors 16 are fabricated from materials that are capable of buckling and resistant to harsh environmental elements (e.g., heat, oxidation, ozone and weather aging). Materials suitable for use as flexible connectors 16 include, but are not limited to, flexible polyvinyl chloride and flexible polypropylene, such as ethylene propylene diene.

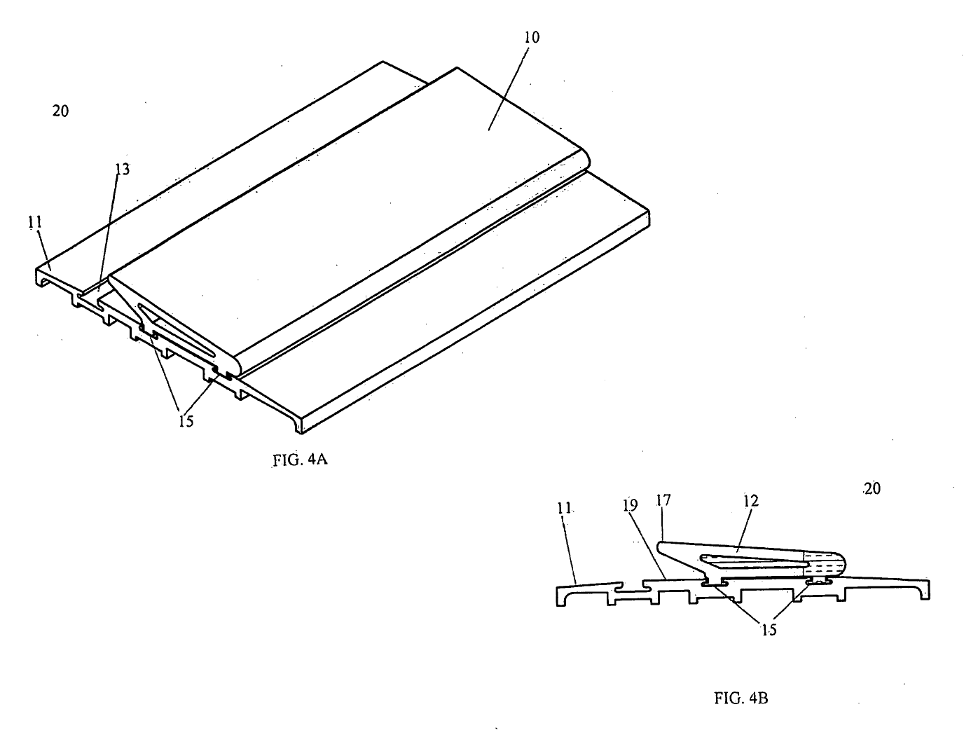

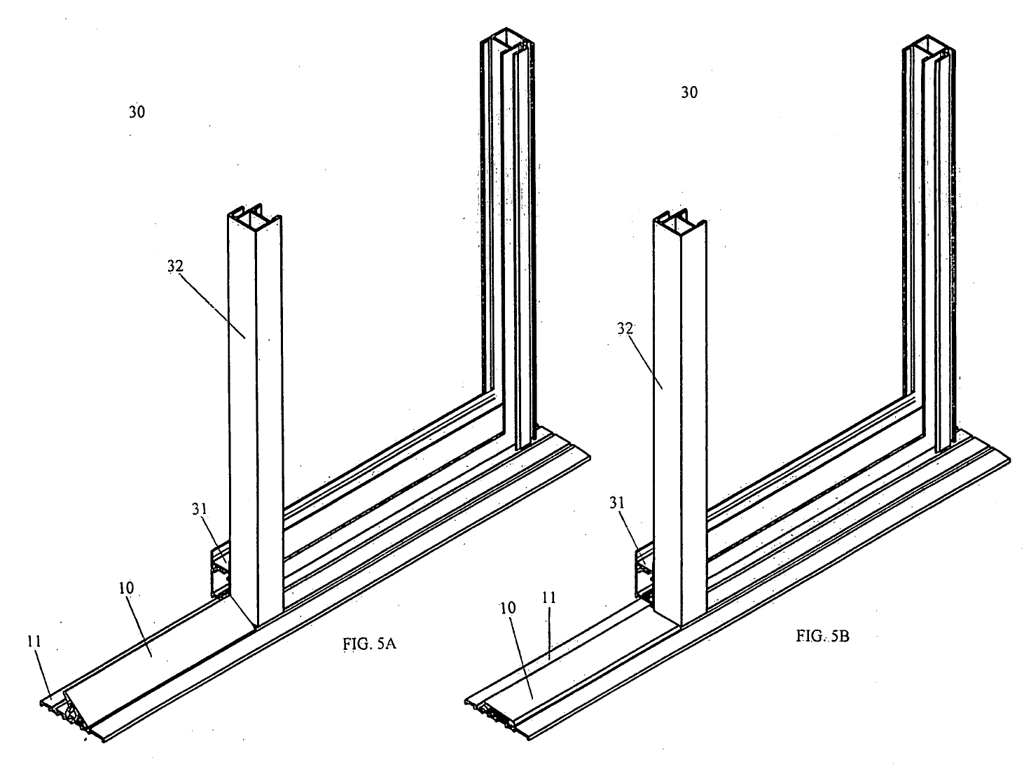

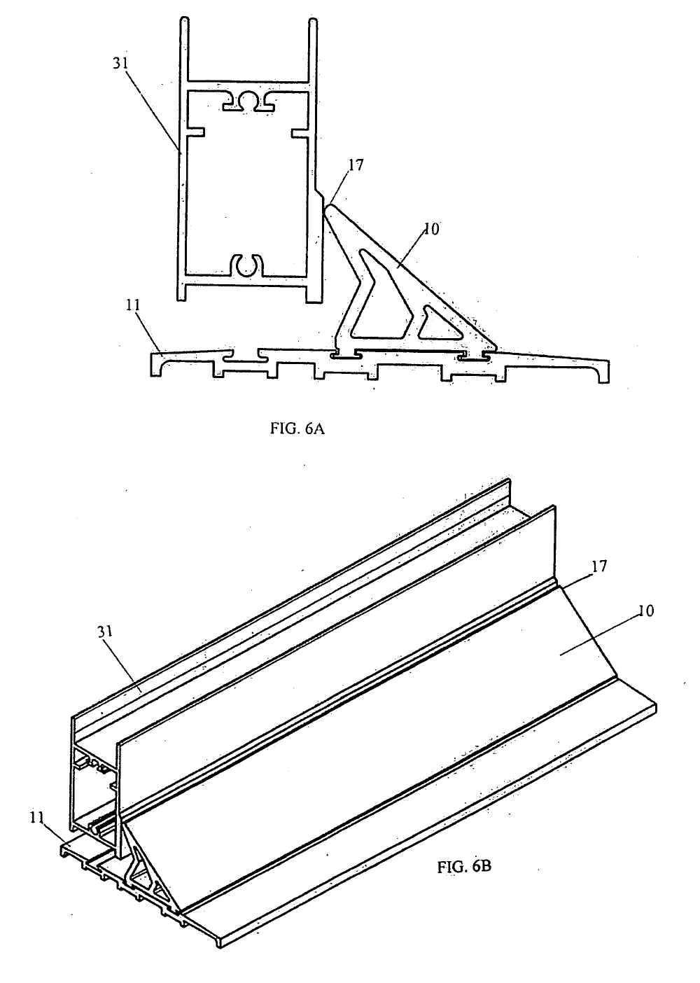

FIGS. 3A and 3B show that portion of a bottom assembly 20 where the threshold 10 of the present invention would be placed. The bottom assembly 20 is shown completely in FIGS. 5A and 5B. As shown in FIGS. 3A and 3B, the threshold 10 is in the raised position. The bottom assembly 20 includes a sill member 11 having a track 13 capable of attaching with a sliding door frame and allowing lateral reciprocating motion of the sliding door frame. The sill member 11 also includes at least one recess 15 corresponding in number to the at least one protrusion 18 of the threshold 10. The at least one recess 15 and the at least one protrusion 18 engage each other such that the threshold 10 is maintained in position on the sill member 11. As shown in FIGS. 4A and 4B, the threshold 10 is in the collapsed position. When the threshold 10 is collapsed, the height h of the collapsed threshold 10 in position within the sill member 11, is chosen so that it meets current ADA height requirements for a door sill. In an embodiment, the collapsed threshold 10 in position within the sill member 11 has an overall height, h, equal to or less than about 0.75 inches. The height h may vary according to current ADA height requirements. When the threshold 10 collapses, a profile of the threshold 10 changes. As shown clearly in FIGS. 3B and 4B, when the upper moveable surface 12 moves in a downward direction towards the lower stationary surface 14, the profile of the threshold 10 changes. For example, a tip portion 17 of the upper moveable surface 12 moves downwards and is in close proximity to a top surface 19 of the sill member 11. The tip portion 17 of the upper moveable surface 12 may include a weatherstripping material. The weatherstripping material acts to increase the weather-strip properties of the threshold 10.

Referring now to FIGS. 5A and 5B, which shows more clearly an entire portion of the bottom assembly 20, the threshold 10 is being used with a sliding door assembly 30, as viewed from an exterior of a building. Only a portion of the sliding door assembly 30 is shown in these figures. The sliding door assembly 30 includes a sliding door 31 (shown as a partial door frame) and a fixed-panel door 32 (shown as a partial door frame). The sliding door 31 is movable between a closed position and an open position. The fixed-panel door 32 is maintained in a stationary position within the sill member 11. As shown in FIG. 5A, the threshold 10 of the bottom assembly 20 is in the raised position, and the sliding door 31 is in an open position. In the raised position, the threshold 10 acts as a weather-strip. When sufficient downward pressure is applied to the upper moveable surface 12, such as pressure exerted from a wheelchair tire, the upper moveable surface 12 moves in a downward direction and collapses onto the lower stationary surface 14 due to the flexible connectors 16. The collapsing of the threshold 10 means that the threshold 10 has changed its profile, and that accessibility through an opening created in the sliding door assembly is achieved. As shown in FIG. 5B, the threshold 10 of the bottom assembly 20 is in the collapsed position, and the sliding door 31 is in the open position.

FIGS. 6A-6B show a portion of the sliding door assembly 30 of FIG. 5A having the threshold 10. The sliding door 31 is shown in the closed position. FIG. 6A is a fragmentary side view of the threshold 10 in relation to the sliding door 31. As shown, the threshold 10 is in the raised position and the tip portion 17 the threshold 10 engages the sliding door 31, resulting in the threshold 10 acting as a weather-strip. FIG. 6B is a perspective view of FIG. 6A, showing an entire length of the tip portion 17 of the threshold 10 engaging the sliding door 31. In one embodiment, the tip portion 17 includes a weatherstripping material.

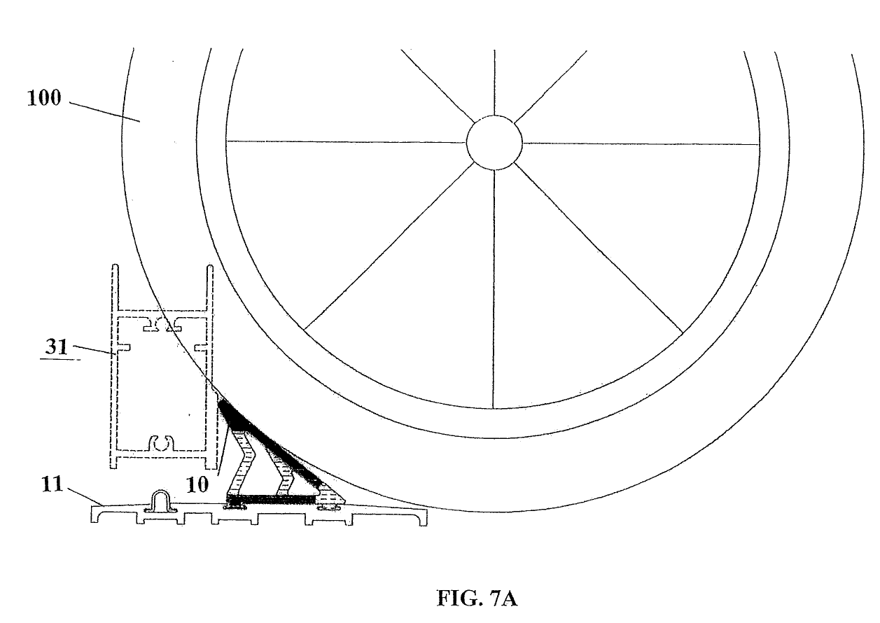

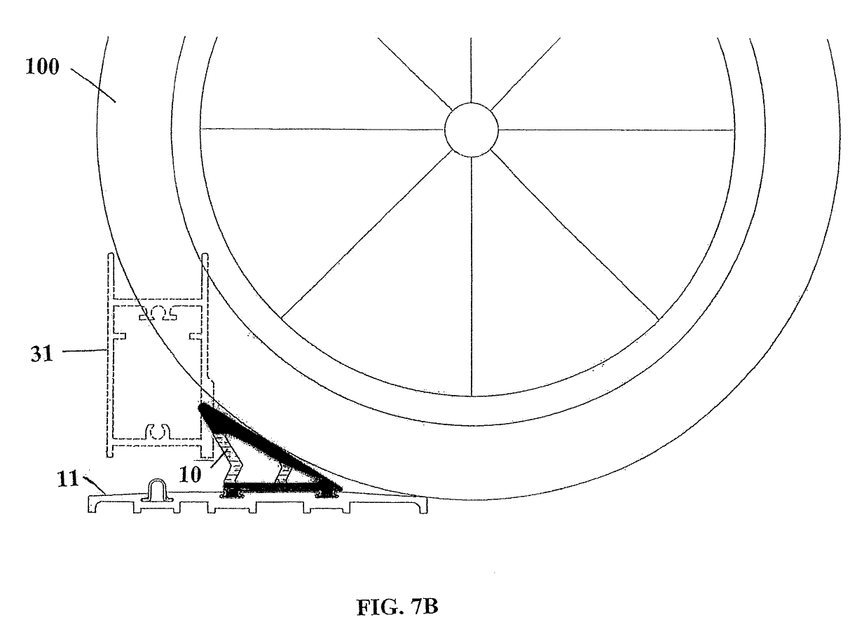

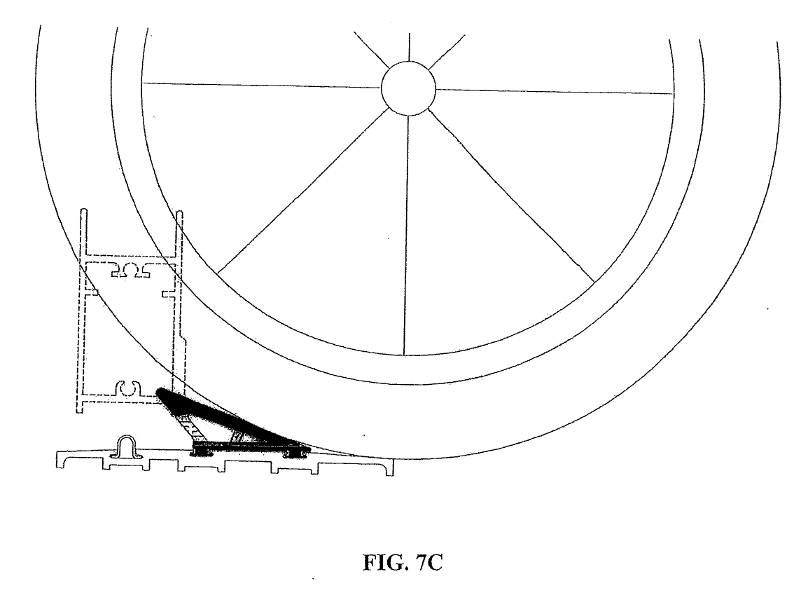

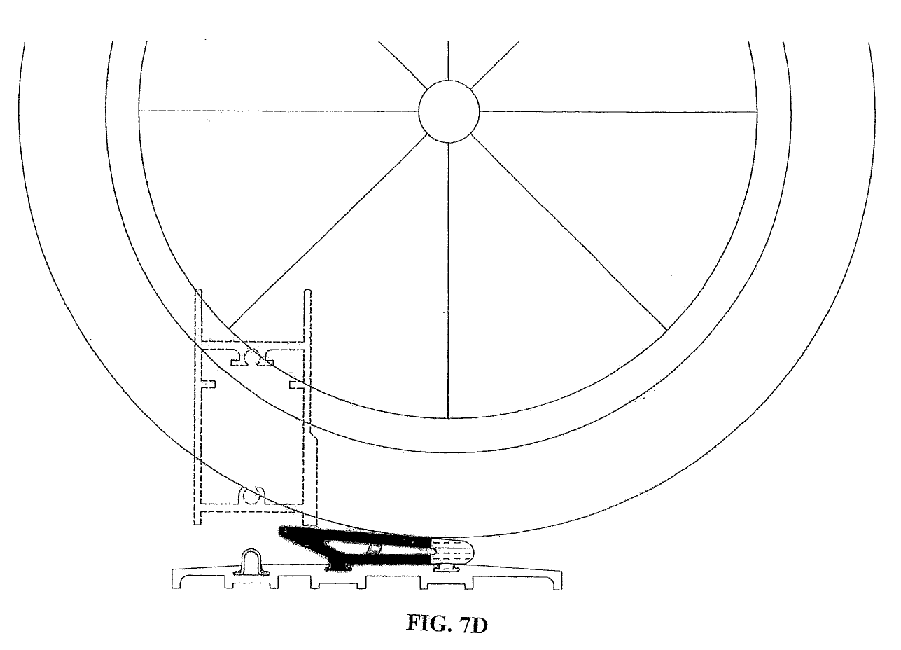

In one embodiment, the threshold 10 moves from the raised position to the collapsed position after a wheelchair tire moves over the threshold 10, as shown in FIGS. 7A-7D. First, the sliding door 31 is in the open position such that an opening is created for the wheelchair to move through. “Open position” refers to the sliding door 31 moving towards and behind the fixed-panel door 32. In this open position, a tire 100 from the wheelchair is capable of passing over the sill member 11 and exerting downward pressure on the upper moveable surface 12 of the threshold 10, causing the upper moveable surface 12 to move from the raised position (as shown in FIG. 7A) to the collapsed position (as shown in FIG. 7D). When downward pressure is applied to the upper moveable surface 12 of the threshold, the flexible connectors 16 buckle, and the upper moveable surface 12 collapses in a downward direction towards the lower stationary surface 14, thus allowing a wheelchair accessibility through the sliding door assembly having the bottom assembly 20. Once the wheelchair tire 100 moves off of the threshold 10, the upper moveable surface 12 of the threshold 10 moves in an upward direction back into the raised position. The flexible connectors 16 are capable of rebounding back into the fully extended position.

While illustrative embodiments of the invention are disclosed herein, it will be appreciated that numerous modifications and other embodiments may be devised by those skilled in the art. Therefore, it will be understood that the appended claims are intended to cover all such modifications and embodiments that come within the spirit and scope of the present invention.

What is claimed is:

1. A bottom assembly for a sliding door comprising:
a threshold having an upper moveable surface, a lower stationary surface and flexible connectors therebetween, wherein the upper moveable surface is capable of moving towards the lower stationary surface when sufficient downward pressure is applied to the upper moveable surface; and
a sill member having a track capable of attaching with the sliding door and allowing lateral reciprocating motion of the sliding door and further comprising at least one recess capable of attaching with the threshold.

2. The bottom assembly of claim 1 wherein the threshold has an overall height equal to or less than about 0.75 inches when the upper moveable surface collapses onto the lower stationary surface.

3. The bottom assembly of claim 1 wherein the lower stationary surface of the threshold includes at least one protrusion for engaging the at least one recess of the sill member.

4. The bottom assembly of claim 1 wherein the upper moveable surface of the threshold includes an additional weatherstripping material engaging the sliding door.

5. The bottom assembly of claim 1 wherein at least part of the threshold is made from a material selected from the group consisting of a polypropylene material, a polyvinyl chloride material and an aluminum material.

6. The bottom assembly of claim 5 wherein the polypropylene material is ethylene propylene diene.

7. The bottom assembly of claim 1 wherein the downward pressure applied to the upper moveable surface of the threshold results in the upper moveable surface moving from a first protective position for substantially preventing water and air intrusion past the sliding door when the sliding door is in a closed position to a second access position for allowing accessibility of a wheelchair through an opening when the sliding door is in an open position.

8. The bottom assembly of claim 1 wherein the downward pressure applied to the upper moveable surface of the threshold is a result of a wheelchair moving over the top rigid portion

9. A sliding door assembly comprising:
a sliding door moveable between a closed position and an open position; and
a door frame surrounding and supporting the sliding door, the door frame including a bottom assembly having a threshold with an upper moveable surface, a lower stationary surface and flexible connectors therebetween, wherein a profile of the threshold changes when the upper moveable surface collapses onto the lower stationary surface.

10. The sliding door assembly of claim 9 wherein the bottom assembly further includes a sill member, the sill member having a track capable of attaching with the sliding door and further comprising at least one recess capable of holding the threshold in place.

11. The sliding door assembly of claim 9 wherein when the sliding door is in the closed position the threshold is in a first protective position for substantially preventing water and air infiltration into a building having the sliding door assembly.

12. The sliding door assembly of claim 9 wherein the upper moveable surface of the threshold collapses onto the lower stationary surface when downward pressure is applied to the upper moveable surface.

13. The sliding door assembly of claim 12 wherein the downward pressure applied to the upper moveable surface is a result of a wheelchair moving over the upper moveable surface.

14. The sliding door assembly of claim 9 wherein the threshold has an overall height equal to or less than about 0.75 inches when the upper moveable surface is collapsed onto the lower stationary surface.

15. The sliding door assembly of claim 10 wherein the lower stationary surface of the threshold includes at least one protrusion for engaging the at least one recess of the sill member.

16. The sliding door assembly of claim 9 wherein the upper moveable surface of the threshold includes a weather-strip that mates with the sliding door.

17. The sliding door assembly of claim 9 wherein at least part of the threshold is made from a material selected from the group consisting of a polypropylene material, a polyvinyl chloride material and an aluminum material.

18. The sliding door assembly of claim 16 wherein the polypropylene material is ethylene propylene diene.

19. The sliding door assembly of claim 11 wherein when the sliding door is in the open position the threshold is capable of moving from the first protective position to a second access position for allowing accessibility of a wheelchair through an opening when the sliding door is in the open position.
